(19) United States
(12) Patent Application Publication
(10) Pub. No.: US 2026/0273672 A1
(43) Pub. Date: Sep. 17, 2026

(54) METHOD AND REPAIR KIT FOR RESTORING A MOUNTING ASSEMBLY, REPAIR KIT, REPAIRED MOUNTING ASSEMBLY, AND AIRCRAFT ENGINE

(71) Applicant: MTU Aero Engines AG, Munich (DE)

(72) Inventor: Joerg SCHNITZLER, Munich (DE)

(21) Appl. No.: 19/448,147

(22) Filed: Jan. 14, 2026

(30) Foreign Application Priority Data
Jan. 16, 2025 (DE) 102025101407.8

(51) Int. Cl. B23P 6/00; B23G 9/00

(52) U.S. Cl. CPC B23P 6/00; B23G 9/009

(57) ABSTRACT

A method for repairing a mounting assembly using a repair kit including a repair screw element, wherein a stud bolt of the mounting assembly connected to a first component of the mounting assembly has broken off. The method includes providing the repair screw element with a screw element sleeve and a screw element head connected thereto. An internal thread of the screw element sleeve corresponds to an external thread remnant of a stud bolt remnant of the stud bolt to form a repair threaded connection. The method includes forming a repair threaded connection between the external thread remnant and the repair screw element by screwing the screw element sleeve through an opening arrangement of a part arrangement and by means of the sleeve internal thread with the external thread remnant. The method includes clamping the part arrangement between the screw element head and the first component.

### CROSS REFERENCE TO RELATED APPLICATIONS

This application claims benefit to German Patent Application No. DE 10 2025 101 407.8, filed on Jan. 16, 2025.

### FIELD

The invention relates to a method for repairing a mounting assembly using a repair kit, to the repair kit itself, to a repaired mounting assembly that includes a broken stud bolt, to the repair kit, and to an engine for an aircraft, wherein the engine includes the repaired mounting assembly.

### BACKGROUND

When repairing or maintaining aircraft, it is extremely important to complete the necessary work quickly in order to minimize unwanted downtime for the aircraft being serviced or repaired. Time-consuming work, especially removing an engine from an aircraft, should be avoided if possible and only carried out as part of a planned overhaul. If a non-safety-critical component of the aircraft is damaged and the component can only be replaced with considerable effort, in particular by removing the engine, it may be repaired as a temporary measure.

However, it must then be accepted that the next overhaul will take longer in order to replace the damaged component with a new one. In addition, the temporary repair must be equipped with its own safety and monitoring elements to ensure that the temporary repair remains in place and is checked regularly.

For example, a stud bolt that can only be removed with considerable effort and onto which a nut is screwed may break off, meaning that a suitable nut can no longer be screwed onto the broken or torn-off stud bolt. As a temporary repair, less important components, such as washers, etc., can be removed and a new nut screwed onto the threads that are still accessible (usually only one or two). As a safety or monitoring measure, a visual twisting or loosening indicator (such as screw locking varnish) can be used, for example, to visually detect any unwanted twisting of the nut provisionally screwed onto the broken stud bolt. However, during the next overhaul, the temporary repair must be removed, i.e., the original condition must be restored, and the broken stud bolt must be replaced with a new one. This results in additional work during overhaul, especially if the engine has to be removed in order to replace the broken stud bolt, meaning that the original condition cannot be restored on-wing.

A repair method is known from WO2022/031712A1. FIG. 3 of WO2022/031712A1 shows a freely accessible remnant of a bolt after a nut has been removed from this remnant (as shown in FIG. 2) and after an outer bolt section (as shown in FIG. 1) has been severed.

### SUMMARY

In an embodiment, the present disclosure provides a method for repairing a mounting assembly using a repair kit including a repair screw element, wherein a stud bolt of the mounting assembly connected to a first component of the mounting assembly has broken off. The method comprises providing the repair screw element of the repair kit with a screw element sleeve and a screw element head connected thereto. An internal thread of the screw element sleeve corresponds to an external thread remnant of a stud bolt remnant of the stud bolt to form a repair threaded connection. The method further comprises forming a repair threaded connection between the external thread remnant and the repair screw element by screwing the screw element sleeve through an opening arrangement of a part arrangement and by means of the sleeve internal thread with the external thread remnant. The method further comprises clamping the part arrangement between the screw element head and the first component of the mounting assembly.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic and sectional exploded view of a repaired mounting assembly; and FIG. 2 shows a schematic and sectional view of the repaired mounting assembly in assembled condition.

### DETAILED DESCRIPTION

In an embodiment, the present disclosure provides for repair of a damaged mounting assembly, particularly in/on an aircraft, as efficiently as possible, whereby the repaired mounting assembly has comparable stability to the original mounting assembly.

The foregoing is achieved by a method for repairing a mounting assembly in which a stud bolt of the mounting assembly has broken off. In the method according to the present disclosure, i.e. to repair the mounting assembly, a repair kit is used that includes a repair screw element.

The undamaged mounting assembly, i.e. the mounting assembly in its original condition, has a first component to which the stud bolt is attached. Furthermore, the undamaged mounting assembly includes an internal thread nut and a part arrangement that includes one part or two or more parts, wherein the part arrangement is clamped between the first component and the internal thread nut. The stud bolt extends through an opening arrangement of the parts arrangement, and the internal thread nut is screwed to the stud bolt or its external thread using a plurality of threads of the stud bolt (in particular more than three threads). In particular, the stud bolt and the female threaded nut are screwed together in such a way that the stud bolt extends axially through the entire female threaded nut, so that all threads of the female threaded nut are occupied.

In the damaged mounting assembly, the stud bolt firmly connected to the first component has broken off or been torn off, for example by applying a loosening force to the female threaded nut screwed onto the stud bolt. As a result, a stud bolt remnant of the former stud bolt, which remains connected to the first component in a torque-proof manner, does not protrude through the opening arrangement of the part arrangement, or does not protrude significantly beyond the part arrangement. The stud bolt remnant also has a free external thread remnant, which is, however, located in the opening arrangement, i.e., largely recessed in the part arrangement, so that an internal thread nut cannot be screwed onto the stud bolt remnant above the part arrangement, or can only be screwed on using a small fraction of the thread turns (in particular, only three or fewer).

The method is applied in particular to the damaged mounting assembly, whereby in one step of the method, the repair screw element of the repair kit is provided with a screw element sleeve and a screw element head firmly connected thereto. The screw element sleeve is provided with an internal thread that corresponds to the external thread of the stud bolt remnant to form a repair threaded connection. Furthermore, the screw element sleeve is elongated, for example at least as long as the internal thread nut or longer. The repair screw element is provided, for example, in such a way that the screw element sleeve and the screw element head are formed integrally with each other. Alternatively, the repair screw element can be provided by two or more individually manufactured components, such as a rod with an external thread and a nut corresponding to the external thread. The screw element sleeve and the screw element head can be connected to each other by force, form, and/or material bonding or can be provided as a single piece, but can also be connected to each other by force, form, and/or material bonding as part of the method.

In a further step of the method, the repair threaded connection is formed between the external thread remnant and the repair screw element by screwing the screw element sleeve through the opening arrangement of the part arrangement and into the external thread remnant by means of the internal thread of the sleeve. This re-clamps the arrangement of parts between the screw head of the repair screw element and the first component of the mounting assembly.

In this way, the damaged mounting assembly is repaired particularly efficiently, whereby the repaired mounting assembly is produced from the damaged mounting assembly, which has a comparable, i.e. at least equal, stability to the original mounting assembly or a higher stability than the original mounting assembly. This is because the screw element sleeve allows the threads arranged in the part arrangement or opening arrangement, which cannot be reached with a normal nut, to be used in the repair threaded connection. In particular, as many threads of the stud bolt remnant are in use as in an original screw connection between the undamaged stud bolt and the female thread nut of the mounting assembly in its original condition. If the repair screw element is provided with a screw element sleeve of the appropriate length, more threads of the stud bolt remnant can be used than in the original screw connection between the undamaged stud bolt and the internal thread nut.

According to an embodiment of the method, the stud bolt remnant and the first component remain connected to each other or firmly fixed to each other during repair of the mounting assembly. This means that the stud bolt remnant forms part of the repaired mounting assembly. The broken stud bolt is therefore not replaced with a new part in this method.

Consequently, the broken stud bolt is not removed, which means that all activities required to remove the stud bolt remnant are omitted. Instead, the stud bolt remnant is used to create the repair threaded connection or the repaired mounting assembly. This takes particular account of the idea of repairing the mounting assembly particularly quickly and efficiently.

According to an embodiment, the external thread residue extends at least in sections through the opening arrangement of the part arrangement. However, the external thread residue does not have to extend beyond the part arrangement, or at least not significantly. The present disclosure advantageously allows the assembly of parts to be secured to the first component by means of the external thread remnant, even if this does not extend beyond the assembly of parts, or does not extend significantly beyond it (i.e. at least not to such an extent that it is still possible to secure the assembly of parts by means of a nut).

According to an embodiment, the stud bolt is broken off below or adjacent to a lost nut, whereby the lost nut was or is attached to a stud bolt section that was lost together with the nut. The repair screw element can, in particular, take over the securing or retaining function of the lost nut.

According to an embodiment, the screwing is carried out in such a way that the inner thread of the sleeve is brought into thread engagement with the outer thread remnant within the part arrangement and/or between the part arrangement and the first component.

In an embodiment of the method, a head-bolt element is used to provide the repair screw element, which has a head portion and a bolt portion connected thereto. The inner thread of the sleeve is formed in the bolt section; if necessary, i.e. if the bolt section has no bore or a bore that is too small, an axial bore is first made in the bolt section in which the inner thread of the sleeve is formed. The screw element sleeve of the repair screw element is therefore formed by the bolt portion of the head bolt element, which has an internal thread. In particular, the screw element head of the repair screw element is formed by the head portion of the head bolt element. In an embodiment, a commercially available cap screw is used as the head bolt element, whereby the bolt portion—and consequently the screw element sleeve of the repair screw element—is formed from an external thread bolt of the cap screw. For this purpose, the inner thread of the sleeve is formed in the external threaded bolt; if necessary, the external threaded bolt is hollow-drilled, and the inner thread of the sleeve is formed in the bore of the external threaded bolt. In particular, a screw head of the head screw is used as the screw element head of the repair screw element. By using readily available or easily manufactured machine elements such as the head bolt element or standard cap screws, the repair screw element can be provided at particularly low cost.

According to a configuration of the method, the screw element sleeve is shortened as required in order to provide the repair screw element or while providing the repair screw element. This prevents the repair screw element's distal end, which is the free screw element sleeve end, from abutting axially against the foot of the stud bolt remnant when the repaired mounting assembly is produced on the first component. This is because the repair screw element would then not be able to be screwed far enough onto the stud bolt remnant, meaning that the parts would not be clamped between the screw element head and the first component, or would not be clamped tightly enough. Consequently, shortening the screw element sleeve as required ensures efficiently and with minimal effort that, when repairing the damaged mounting assembly, the parts are clamped securely and with the desired strength between the screw element head and the first component.

In an embodiment of the method, it is provided that, before forming the repair threaded connection, one or two or more openings of the opening arrangement are adapted to an outer diameter of the screw element sleeve by means of a machining and/or non-machining process. This is particularly necessary for parts of the part arrangement whose opening, through which the stud bolt extended in the undamaged mounting assembly, has an opening dimension (for example, an opening diameter in the case of a circular opening or an opening width in the case of a slotted hole) that is as large as or only slightly larger than the outer diameter of the stud bolt. This is because the screw element sleeve encloses the stud bolt remnant on the outer circumference, which means that the outer diameter of the screw element sleeve is larger than the outer diameter of the stud bolt. It is therefore necessary to adjust the opening or openings, in particular if the screw element sleeve cannot be inserted axially through the corresponding original opening due to its excessive outer diameter. The corresponding opening can be adjusted, for example, by drilling, cutting, flaring, etc. This makes it particularly easy to guide the repair screw element through the parts or opening arrangement in order to repair the mounting assembly.

According to an embodiment of the method, before forming the repair threaded connection, one part or two or more parts of the part arrangement are replaced with a corresponding repair part that is manufactured with an opening for the opening arrangement of the repaired mounting assembly. The opening of the repair part corresponds to the outer diameter of the screw element sleeve, so that the screw element sleeve can be easily passed axially through the opening of the repair part. Replacing the original part or parts of the undamaged mounting assembly is particularly advisable if the corresponding original part can be removed from the part arrangement or mounting assembly without great effort, for example if it is already completely loose in the damaged mounting assembly and only needs to be removed. This has the advantage of eliminating the need for machining/non-machining of the original part, which can be replaced with little effort, further facilitating the rapid completion of repairs to the damaged mounting device. With regard to the embodiment described in the preceding paragraph, it should be understood, for example, that one or more of the parts of the part arrangement can be machined and/or non-machined, and one or more of the other parts of the same part arrangement can be replaced with a corresponding repair part.

According to an embodiment, the method includes an additional step in which, after forming the repair threaded connection, the repair screw element is locked against rotation by means of an anti-rotation device. In particular, the anti-rotation device is designed as a form-fitting anti-rotation device. The anti-rotation device is designed, for example, to act in a form-fitting manner between the component arrangement and the head portion of the repair screw element, whereby the repair screw element, in particular its screw element head, is locked in a form-fitting manner to the part arrangement by means of the anti-rotation device. For example, it can be provided that a securing cable (such as a wire) is passed through a securing opening in the screw element head and tensioned to a securing element fixed to the part arrangement or elsewhere. This locks the repair threaded connection or repair screw element particularly reliably to prevent unwanted loosening, making the repaired mounting device even more secure.

An embodiment provides that the anti-rotation device is formed by inserting a repair washer which has two form-fitting elements. The anti-rotation device is designed in such a way that, once the repair threaded connection has been made, one of the form-fitting elements engages in a form-fitting manner in a first form-fitting element receptacle of the repair screw element, in particular the screw element head, whereas the other form-fitting element engages in a form-fitting manner in a second form-fitting element receptacle of the part arrangement. The first form-fitting element receptacle is thus firmly connected to the repair screw element, in particular to its screw element head, whereby the second form-fitting element receptacle is firmly connected to the part arrangement. The repair washer has form-fitting elements, such as tabs extending radially outward, which are bent into the corresponding form-fitting element receptacle after the repair threaded connection has been formed. The repair washer has the advantage that the anti-rotation device can be formed particularly close to the repair screw element and, apart from the portion of the part arrangement connected to the form-fitting element of the repair washer, there is no need to modify or replace any other component of the mounting assembly. Both the original washer and the repair washer can be used in the repaired mounting assembly. The original washer of the mounting assembly can also be replaced with the repair washer, i.e. that the repair washer can be installed in place of the original washer. In the latter case, there is no axial enlargement of the repaired mounting assembly compared to the original mounting assembly.

In an embodiment of the method, it is applied to an aircraft engine, whereby the engine remains mounted in its intended installation position on/in the aircraft during repair of the mounting assembly. In other words, the method is used for what is known as on-wing repair of the engine, in particular its mounting assembly. The engine features a fluid flow machine in particular. It is a significant advantage when the method is used as an on-wing repair method, because with on-wing repairs, the engine does not need to be removed from the aircraft or dismantled from the aircraft wing. This allows the repair of the mounting assembly to be completed particularly quickly, and consequently any undesirable, especially unplanned, downtime of the engine or aircraft is kept to a minimum. In particular, the method is applied to an ACC housing assembly of the engine (ACC: active clearance control, sometimes also active tip-clearance control), wherein in the undamaged mounting assembly, a component of the ACC housing assembly, in particular an air duct device of the ACC housing assembly, is attached to an inner housing of the engine. In particular, the inner housing forms the first component of the mounting assembly, whereby the stud bolt and the inner housing are connected to each other by force, form, and/or material. For example, the stud bolt can extend radially outward from inside the inner housing through a stud bolt opening in the inner housing, with its external thread protruding beyond an outer circumferential surface of the inner housing. The stud bolt and the stud bolt opening can be connected to each other, for example, by means of cold stretching/expansion. Other embodiments of the connection between the inner housing and the stud bolt can also be provided, such as a welded connection, a screw connection, etc. In particular, if the stud bolt can only be separated from the inner housing radially inwards, for example due to a stud bolt head, it is necessary to remove the engine from the aircraft and dismantle it at least to the extent that the stud bolt in the inner housing can be reached and removed, which is considerably time-consuming. This method eliminates the need to replace the stud bolt. As a result, it is also not necessary to disassemble the engine, in particular its ACC housing assembly, any further than is necessary to reach the stud bolt remnant in order to repair it. Particular attention should be paid to the fact that, advantageously, the engine does not need to be removed from the aircraft.

The repair kit used in the above-described method for repairing the mounting assembly or for producing the repaired mounting assembly from the damaged mounting assembly provides a further advantage of the present disclosure. The repair kit has one repair kit element or two or more repair kit elements. The first repair kit element in the repair kit is the repair screw element.

According to an embodiment, the repair kit also includes one or more of the following additional repair kit elements:
A repair spacer element designed to replace an original spacer element of the undamaged mounting assembly.
A repair ring washer designed to replace an original washer from the undamaged mounting assembly. The repair ring washer can be designed as a repair washer, i.e. it can have the form-fitting elements of the anti-rotation device.
A repair tension spring element designed to replace an original tension spring element of the undamaged mounting assembly. In particular, the tension spring element is designed as a disc spring, which supports the axial tensioning of the component arrangement between the first component and the internal thread nut of the original mounting assembly.
A repair part designed to replace part of the original part arrangement of the undamaged mounting assembly. In particular, the part is a component of the ACC housing assembly.

An aspect of the present disclosure relates to the repaired mounting assembly, which comprises the broken stud bolt—i.e. the stud bolt remnant-and the repair kit. In particular, the repair threaded connection is formed between the repair screw element of the repair kit and the stud bolt remnant.

In the repaired mounting assembly, the stud bolt remnant can be connected to one or the aforementioned first component. The repair screw element and the stud bolt remnant can be used to clamp one or the aforementioned part arrangement between the first component and one or the aforementioned screw element head of the repair screw element.

An aspect of the present disclosure relates to an engine for an aircraft, wherein the engine comprises, in particular, a fluid flow machine. In particular, the engine is designed as a turbofan engine with a gear ratio between a low-pressure shaft and a fan shaft. Such engines are also referred to as Geared Turbofan engines or Geared Turbofans (GTFs). The engine features the repaired mounting assembly, whereby in particular the repaired threaded connection can be created or detached while the engine is attached to an aircraft wing, i.e. “on-wing.” The engine can have two or more mounting devices, whereby one or more of the mounting devices is/are original, i.e. undamaged, and one or more of the mounting devices is/are repaired, i.e. has/have the stud bolt remnant and the repair kit or the repair screw element.

Further characteristics are evident from the following description in connection with the figures.

The following describes a method and a repair kit 1 for producing a repaired mounting assembly 2, as well as the repaired mounting assembly 2 and an aircraft engine 3 featuring the repaired mounting assembly 2, in a joint description. Identical elements with the same function are marked with the same reference symbol.

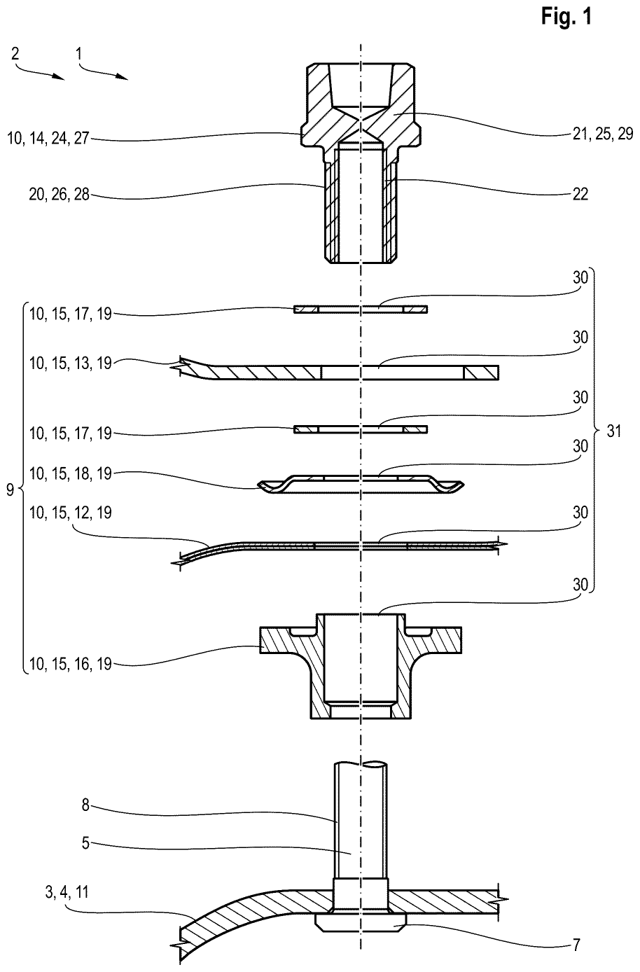

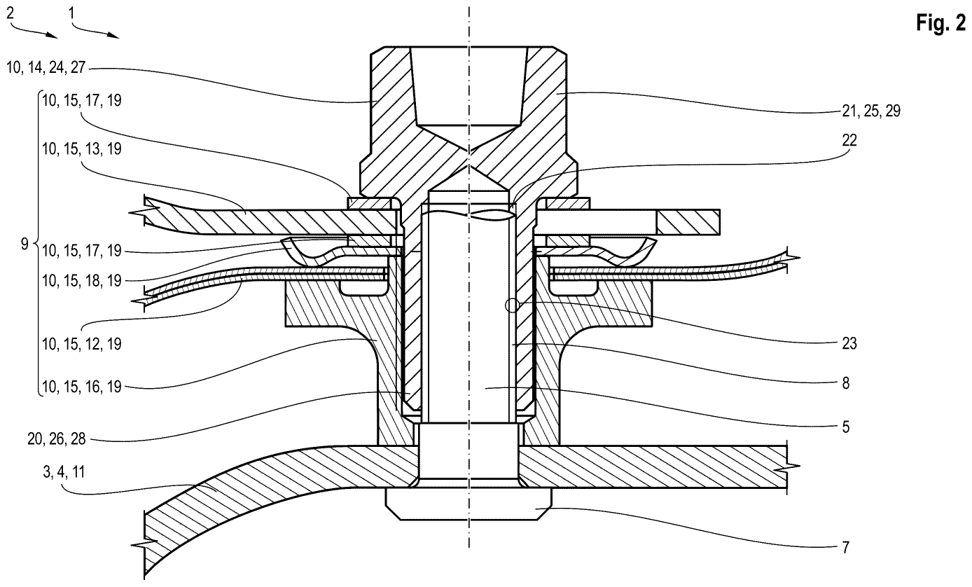

FIG. 1 shows an exploded view of the repaired mounting assembly 2, and FIG. 2 shows a schematic and sectional view of the repaired mounting assembly 2 in assembled condition. The repaired mounting assembly 2 is produced from an original or undamaged mounting assembly using the method or repair kit 1. The repaired mounting assembly 2 has a first component 4 to which a stud bolt remnant 5 is fixed, which originates from a stud bolt that has broken off or been torn off. The stud bolt remnant 5 is inserted into a stud bolt opening 6 of the first component 4. Furthermore, it can be seen that the stud bolt remnant 5 or the former stud bolt has a stud bolt head 7 and can therefore only be removed from the first component 4 in one direction. The stud bolt remnant 5 has an external thread remnant 8. FIG. 1 and FIG. 2 also show a component arrangement 9, whose components 10 were attached to the first component 4 by means of the undamaged mounting assembly and/or are attached to the first component 4 by means of the repaired mounting assembly 2 (see FIG. 2). The first component 4 in this case is an inner housing 11 of the engine 3, wherein the component arrangement 9—as the respective component 10—has at least one air duct device 12 and a mounting strip 13 of an ACC housing arrangement of the engine 3.

In addition to the broken stud bolt or stud bolt remnant 5, the repaired mounting assembly 2 features the repair kit 1, which includes a repair screw element 14. In this case, repair kit 1 also has another repair kit element 15, namely a repair spacer element 16, which replaces an original spacer element of the undamaged mounting assembly. According to the present example, another repair kit element 15 of repair kit 1 is formed by a repair ring washer 17. Here in the example, the repaired mounting assembly 2 has two or two or more repair ring washers 17, whereby the respective repair ring washer 17 replaces an original washer of the undamaged mounting assembly. In addition, repair kit 1 includes a repair tension spring element 18 as a further repair kit element 15, which replaces an original tension spring element of the undamaged mounting assembly. One or more of the parts 10 can be a respective repair part 19, wherein the respective repair part 19 forms a further repair kit element 15 of the repair kit 1. The respective repair part 19 is designed to replace the corresponding part 10 of the part arrangement 9 in the repaired mounting assembly 2. One, some, or all of the parts 10 can therefore be reused or continued to be used in the repaired mounting assembly 2, or replaced with a corresponding repair part 19. In this example, the repair kit elements 15 are each part 10 of the part arrangement 9.

In step S1 of the method, the repair screw element 14 of the repair kit 1 is provided with a screw element sleeve 20 and a screw element head 21 firmly connected thereto. The screw element sleeve 20 and the screw element head 21 are/will be connected to each other by force, form, and/or material bonding, in this case formed integrally with each other. The screw element sleeve 20 is elongated, for example at least as long as an internal thread nut of the original mounting assembly or longer. Furthermore, the screw element sleeve 20 is provided with an internal sleeve thread 22 that corresponds to the external thread remnant 8 of the stud bolt remnant 5 to form a repair threaded connection 23 (see FIG. 2). Furthermore, when providing the repair screw element 14, its screw element sleeve 20 is shortened as required, for example by twisting it off. In particular, the repair screw element 14 is provided by providing a head bolt element 24 having a head portion 25 and a bolt portion 26 connected thereto, in which the sleeve internal thread 22 is formed. In this case, the head-bolt element 24 is provided as a commercially available cap screw 27, whereby the bolt portion 26—and consequently the screw element sleeve 20 of the repair screw element 14—is formed from an external thread bolt 28 of the cap screw 27. The head portion 25 or the screw element head 21 of the repair screw element 14 is then formed by a screw head 29 of the head screw 27.

It is further apparent from FIG. 1 and FIG. 2 that the parts 10 each have an opening 30, wherein the openings 30 together form an opening arrangement 31 of the part arrangement 9. For reasons of clarity, the opening arrangement 31 and the openings 30 in FIG. 2 are not provided with the corresponding reference symbols. The stud bolt remnant 5 extends through the openings 30 or opening arrangement 31. If an opening 30 is too small for the screw element sleeve 20 to pass through axially, in the present example, before forming the repair threaded connection 23, the corresponding opening 30 is adapted to the outer diameter of the screw element sleeve 20.

This can be done, for example, by adapting the corresponding opening 30 to the outer diameter of the screw element sleeve 20 using a machining and/or non-machining process. Furthermore, the opening 30 can be adjusted by replacing the part 10 with the opening 30 that is too small with the corresponding repair part 19, which is manufactured with the opening 30 that is sufficiently large for the opening arrangement 31 of the repaired mounting assembly 2.

In a further step S2 of the method, the repair threaded connection 23 is then formed between the external thread remnant 8 and the repair screw element 14 by screwing the screw element sleeve 20 through the opening arrangement 31 of the part arrangement 9 and into the external thread remnant 8 by means of the sleeve internal thread 22. This clamps the part assembly 9 between the screw element head 21 of the repair screw element 14 and the first component 4 of the repaired mounting assembly 2. The stud bolt remnant 5 and the first component 4 remain connected to each other during the repair of the damaged mounting assembly—i.e. during the manufacture of the repaired mounting assembly 2. The stud bolt remnant 5 forms part of the repaired mounting assembly 2. The broken stud bolt or the stud bolt remnant 5 is therefore not replaced with a new stud bolt. In the repaired mounting assembly 2, the repair threaded connection 23 is formed between the repair screw element 14 and the stud bolt remnant 5.

In the present example, it is further provided that a further step S3 of the method involves forming an anti-rotation device by means of which the repair threaded connection 23 is locked to prevent unintentional loosening. The anti-rotation device is designed here as a form-fitting anti-rotation device, for example by means of a securing cable that is fed through a securing opening in the screw element head and tensioned to a securing element fixed to the part arrangement 9 or elsewhere. Alternatively or additionally, the anti-rotation device can include a repair washer with two form-fitting elements, each designed as a tab, as well as a first form-fitting element receptacle fixed to the screw element head 21 and a second form-fitting element receptacle fixed to the component assembly 9. Then the anti-rotation device is formed by bending one of the tabs into the first form-fitting locking element receptacle and the other tab into the second form-fitting locking element receptacle once the repair threaded connection 23 has been made. In particular, it is envisaged that the repair ring washer 17 is designed as the repair washer.

In accordance with the present example, the method is applied to engine 3 of an aircraft while it remains mounted in its intended installation position on/in the aircraft, in particular suspended from a wing of the aircraft. In other words, the method is used for the so-called on-wing repair of engine 3, in particular the ACC housing assembly.

Engine 3 includes, in particular, a flow machine which is designed, for example, as a low-pressure gas turbine. In this case, engine 3 is designed as a turbofan engine with a gear ratio between a low-pressure shaft and a fan shaft, i.e. as a Geared Turbofan (GTF) engine. The engine 3 features the repaired mounting assembly 2, whereby the repaired threaded connection 23 can be manufactured or detached while the engine 3 is attached to the aircraft wing, i.e. “on-wing.” Engine 3 can have two or more mounting devices, whereby one or more of the mounting devices is/are original, i.e. undamaged, and one or more of the mounting devices is/are repaired, i.e. has/have the stud bolt remnant 5 and the repair kit 1 or the repair screw element 14.

The method, repair kit 1, repaired mounting assembly 2, and engine 3 show a way of solving the task described at the outset, namely repairing a damaged mounting assembly, particularly in/on an aircraft, as efficiently as possible.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE LIST

1 repair kit
2 repaired mounting assembly
3 engine
4 first component
5 stud remnant
6 stud hole
7 stud head
8 external thread remnant
9 part arrangement
10 part
11 inner casing
12 air duct system
13 mounting strip
14 repair screw element
15 repair kit element
16 repair spacer element
17 repair ring washer
18 repair tension spring element
19 repair part
20 screw element sleeve
21 screw element head
22 internal thread
23 repair threaded connection
24 head bolt element
25 head portion
26 bolt portion
27 head screw
28 external threaded bolt
29 screw head
30 opening
31 opening arrangement

1. A method for repairing a mounting assembly using a repair kit including a repair screw element, wherein a stud bolt of the mounting assembly connected to a first component of the mounting assembly has broken off, the method comprising:
providing the repair screw element of the repair kit with a screw element sleeve and a screw element head connected thereto, wherein an internal thread of the screw element sleeve corresponds to an external thread remnant of a stud bolt remnant of the stud bolt to form a repair threaded connection;
forming a repair threaded connection between the external thread remnant and the repair screw element by screwing the screw element sleeve through an opening arrangement of a part arrangement and by means of the sleeve internal thread with the external thread remnant; and
clamping the part arrangement between the screw element head and the first component of the mounting assembly.

2. The method according to claim 1, wherein:
the stud bolt remnant and the first component remain connected to each other during repair of the mounting assembly,
the external thread remnant extends at least in sections through the opening arrangement of the part arrangement, but the external thread remnant does not extend beyond the part arrangement,
the stud bolt has broken off below or adjacent to a lost nut, whereby the lost nut was or is attached to a stud bolt section that has been lost together with the nut, and in the repair screw element takes over the securing or retaining function of the lost nut, and/or
the screwing is carried out such that the inner thread of the sleeve is brought into thread engagement with the outer thread remnant within the part arrangement and/or between the part arrangement and the first component.

3. The method according to claim 1, comprising using a head bolt element to provide the repair screw element, which has a head portion and an associated bolt portion in which the inner thread of the sleeve is formed, such that the screw element sleeve is formed by the bolt portion having the sleeve internal thread.

4. The method according to claim 3, wherein a commercially available cap screw is used as the head bolt element, and wherein an external threaded bolt of the cap screw is used as the bolt portion, in which the sleeve internal thread is formed.

5. The method according to claim 1, comprising shortening the screw element sleeve to provide the repair screw element.

6. The method according to claim 1, comprising, before forming the repair threaded connection, adapting an opening of the opening arrangement to an outer diameter of the screw element sleeve by a machining and/or non-machining process.

7. The method according to claim 1, comprising, before forming the repair threaded connection, replacing a part of the part arrangement by a corresponding repair part that is manufactured with an opening for the opening arrangement corresponding to an outer diameter of the screw element sleeve.

8. The method according to claim 1, comprising locking the repair screw element to prevent rotation by an anti-rotation device.

9. The method according to claim 8, comprising forming the anti-rotation device by inserting a repair washer that has two form-fitting elements, such that when the repair threaded connection is established;
one of the two form-fitting elements engages in a first form-fitting element receptacle of the repair screw element, and
another of the two form-fitting elements engages in a second form-fitting element receptacle of the part arrangement.

10. The method according to claim 1, the mounting assembly is part of an active clearance control (ACC) housing assembly of an engine of an aircraft, and wherein the engine remains mounted in an intended installation position on or in the aircraft.

11. A repair for repairing a mounting assembly, which includes a repair screw element as a repair kit element.

12. The repair according to claim 11, further comprising one or more of:
a repair spacer element configured to replace a spacer element of the mounting assembly,
a repair ring washer configured to replace a washer of the mounting assembly,
a repair tension spring element configured to replace a tension spring element of the mounting assembly, and/or
a repair part configured to replace a part of the part arrangement of the mounting assembly.

13. A repaired mounting assembly comprising a broken-off stud bolt and the repair kit according to claim 11, wherein a repair threaded connection is formed between the repair screw element and a stud bolt remnant.

14. The repaired mounting assembly according to claim 13, wherein the stud bolt remnant is connected to a first component, wherein the repair screw element and a part arrangement are clamped, via the stud bolt remnant, between the first component and a screw element head of the repair screw element

15. An engine for an aircraft with the repaired mounting assembly according to claim 13, wherein the repair threaded connection is configured to be created or detached while the engine is attached to an aircraft wing of the aircraft.
